(19) United States
(12) Patent Application Publication
(10) Pub. No.: US 2026/0161214 A1
(43) Pub. Date: Jun. 11, 2026

(54) Low Power Controlling of Data Interface Devices

(71) Applicant: PARADE TECHNOLOGIES, LTD., San Jose, CA (US)

(72) Inventors: Hongquan Wang, Shanghai (CN); Qing Chen, Nanjing (CN); Liang Chang, Shanghai (CN); Shengyuan Zhang, Shanghai (CN)

(21) Appl. No.: 18/975,846

(22) Filed: Dec. 10, 2024

(51) Int. Cl. G06F 1/3287; G06F 1/3234

(52) U.S. Cl. CPC G06F 1/3287; G06F 1/3278

(57) ABSTRACT

This application is directed to controlling power consumption of a data interface of an electronic device. The electronic device includes a data port for coupling the electronic device to an external device, a data interface circuit coupled to the data port, and a power controller coupled to the data interface circuit. The data interface circuit is configured to receive a first power signal provided based on an interface power control signal and exchange data with the external device coupled via the data port. The power controller is configured to receive a second power signal distinct from the first power signal, monitor an interface operation state of the data interface circuit, and generate the interface power control signal based on the interface operation state. In some implementations, the power controller includes latches for holding state signals corresponding to the interface operation state, before and while the first power signal is disabled.

### TECHNICAL FIELD

The disclosed embodiments relate generally to data transmission technology, including methods, systems, and devices for managing power states of a data interface circuit of an electronic device (e.g., coupled to a high-speed data communication channel).

### BACKGROUND

Many electronic devices are physically interconnected and communicate through data links and interfaces that adhere to an industry bus standard, which defines the physical interfaces, communication protocols, and power delivery methods for host connections and data transfer. The bus standard allows the application of redriver or retimers to extend the channel and reach at a high data speed. When no data is being communicated, power consumption in data interfaces using redrivers and retimers can pose a concern, particularly in systems designed for high-speed data transmission.

### SUMMARY

In accordance with some embodiments of this application is at least a realization that power management features are needed to dynamically reduce power consumption of a data interface circuit of an electronic device during inactivity of a data communication link and maintain a balance between low latency and efficient power use to avoid delays when resuming data transmission. In some embodiments, the data interface circuit corresponds to a redriver. The redriver is an analog extension device (e.g., an amplifier) configured to boost portions of a signal to counteract attenuation caused by signal propagation over a physical interconnect of a corresponding data link. In some embodiments, the data interface circuit corresponds to a retimer, which is a mixed-signal device that is configured to recover data, extract an embedded clock, and retransmit a fresh copy of the data using a clean clock. The retimer may apply a bus standard to implement negotiation, timeouts, bit manipulation, jitter resetting, signal equalization, skew correction, and many other functions.

Various embodiments of this application are directed to methods, electronic systems, electronic devices, electronic circuits, data links, data ports, and data interfaces that manage power states of a data interface circuit associated with a data communication link. In some embodiments, the data interface circuit corresponds to a core module of a retimer, and is powered separately from a power controller of the retimer. An interface power control signal is generated by the power controller to control power consumption of the data interface circuit. In accordance with a determination that the interface power control signal has a first voltage level (e.g., “0”), the data interface circuit is turned off and the re-timer enters a low power mode. Conversely, in accordance with a determination that the re-timer is in a wakeup mode (e.g., upon receiving a data stream), the interface power control signal transitions from the first voltage level to a second voltage level, prompting activation of the data interface circuit.

In some embodiments, a retimer operates in a plurality of voltage domains corresponding to at least a first power signal and a second power signal. The retimer includes a core module coupled to, and powered by, a dominant voltage source that supplies the first power signal, which may be determined based on one or more specific application requirements. The interface power control signal is generated by a power controller to control a switch component coupling the core module to the dominant voltage source. The power controller is powered by the second power signal, independently of the first power signal. In some embodiments, the second power signal is generated by a voltage regulator (e.g., a low-dropout regulator). When the retimer operates in a low power state, the power controller stays connected to the second power signal and provides the interface power control signal to electrically decouple the first power signal from at least the core module of the retimer, thereby conserving power consumption of the core module of the retimer.

In some embodiments, the dominant voltage source includes a voltage converter for generating the first power signal, which powers the core module of the retimer. Alternatively, in some embodiments, a switch component is applied to connect the first power signal to the core module of the retimer. The voltage converter and the switch component are controlled by the power controller that is constantly powered on.

In one aspect of this application, an electronic device includes a data port for coupling the electronic device to an external device, a data interface circuit coupled to the data port, and a power controller coupled to the data interface circuit. The data interface circuit is configured to receive a first power signal provided based on an interface power control signal and exchange data with the external device coupled via the data port. The power controller is configured to receive a second power signal, monitor an interface operation state of the data interface circuit, and generate the interface power control signal based on the interface operation state. The second power signal is distinct from the first power signal.

In one aspect, a data interface device (e.g., a retimer) includes a data port for coupling the electronic device to an external device, a data interface circuit coupled to the data port, and a power controller coupled to the data interface circuit. The data interface circuit is configured to receive a first power signal provided based on an interface power control signal and exchange data with the external device coupled via the data port. The power controller is configured to receive a second power signal, monitor an interface operation state of the data interface circuit, and generate the interface power control signal based on the interface operation state. The second power signal is distinct from the first power signal.

In another aspect, a non-transitory computer-readable storage medium stores one or more programs to be executed by a power controller of an electronic device. The electronic device includes a data port for coupling the electronic device to an external device, a data interface circuit coupled to the data port, and a power controller coupled to the data interface circuit. The data interface circuit is configured to receive a first power signal provided based on an interface power control signal and exchange data with the external device coupled via the data port. The power controller receives a second power signal. The one or more programs include instructions for monitoring an interface operation state of the data interface circuit and generating the interface power control signal based on the interface operation state.

In yet another aspect, a method is implemented to manage power consumption of an electronic device. The method includes obtaining a first power signal provided based on an interface power control signal and powering a data interface circuit with the first power signal. The data interface circuit is coupled to a data port and configured to exchange data with an external device coupled via the data port. The method further includes obtaining a second power signal, and the second power signal is distinct from the first power signal. The method further includes powering a power controller coupled to the data interface circuit with the second power signal. The method further includes, at the power controller, monitoring an interface operation state of the data interface circuit and generating the interface power control signal based on the interface operation state.

In yet another aspect, a method is implemented to providing an electronic device. The method includes providing a data port for coupling the data interface device to an external device and providing a data interface circuit coupled to the data port. The data interface circuit is configured to receive a first power signal provided based on an interface power control signal and exchange data with the external device coupled via the data port. The method further includes providing a power controller coupled to the data interface circuit, and the power controller is configured to receive a second power signal, monitor an interface operation state of the data interface circuit, and generate the interface power control signal based on the interface operation state. The second power signal is distinct from the first power signal.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram of an example electronic system in which electronic devices are electrically connected via a data link, in accordance with some embodiments.

FIG. 2 is an example PCI Express electronic system in which a first electronic device or component is electrically coupled to a second electronic device or component via a data link, in accordance with some embodiments.

FIGS. 3A and 3B are two example electronic systems in which a data link is coupled between two electronic devices or components and includes at least one retimer, in accordance with some embodiments.

FIG. 4A is a block diagram an example electronic system in which a first electronic device or component is electrically coupled to a second electronic device or component via a data link, in accordance with some embodiments.

FIG. 4B is a block diagram of an example data link including a plurality of modulation circuits, in accordance with some embodiments.

FIGS. 5A and 5B are block diagrams of two example electronic devices that control power consumption of a data interface circuit, in accordance with some embodiments.

FIG. 6 is a block diagram of an example power controlling system applied to control a first power signal of a data interface circuit, in accordance with some embodiments.

FIG. 7A is a temporal diagram of example voltage signals of an electronic device having a data interface circuit that alternates between a low power mode and a wakeup mode, in accordance with some embodiments.

FIG. 7B is a temporal diagram of example voltage signals of an electronic device having a data interface circuit that switches from a low power mode to a wakeup mode, in accordance with some embodiments.

FIG. 8 is a flow diagram of an example method for controlling power consumption of a data interface circuit of an electronic device, in accordance with some embodiments.

FIG. 9 is a flow diagram of an example method for providing a data interface circuit of an electronic device, in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

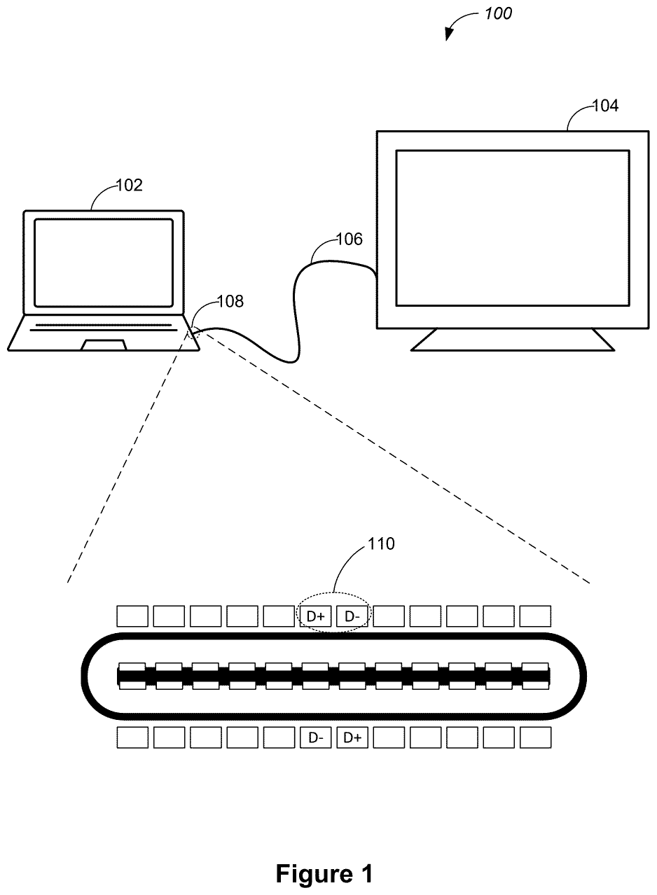

FIG. 1 is a block diagram of an example electronic system 100 in which a first electronic device 102 is electrically coupled to a second electronic device 104 via a data link 106, in accordance with some embodiments. The first electronic device 102 and second electronic device 104 are configured to exchange data via the data link 106. In some embodiments, the first electronic device 102 includes a video source, and the second electronic device 104 includes a display device. The display device has a screen configured to display visual content provided by the first electronic device 102 via the data link 106. In another example not shown, the first electronic device 102 is a desktop computer and the second electronic device 104 is a mobile phone that exchanges data with the desktop computer via the data link 106. Examples of the electronic devices 102 and 104 include, but are not limited to, a desktop computer, a laptop computer, a tablet computer, a video player, a camera device, a gameplayer device, and other formats of electronic devices that are configured to provide data or receive data. Video data, audio data, text, program data, control data, configuration data, or any other data is transmitted between the first and second electronic devices 102 and 104 via the data link 106.

Connectors 108 include connectors incorporated into electronic devices as well as connectors at the ends of cables, such as the data link cable 106. The data link cable 106 includes a connector 108 at each end. The two data link connectors 108 are configured to connect the data link 106 to respective connectors 108 of the first electronic device 102 and second electronic device 104. In some embodiments, the connectors 108 are DisplayPort connectors having a digital display interface developed by a consortium of personal computer and chip manufacturers and standardized by the Video Electronics Standards Association (VESA). The DisplayPort connectors are configured to connect the data link 106 to the first electronic device 102 and carry video, audio, and control data according to a data communication protocol. In another example, the connectors 108 are universal serial bus (USB) connectors (e.g., configured to connect a computer to a peripheral device). Exemplary types of USB connectors include, but are not limited to, USB-A, USB-B, USB-C, USB Micro-A, USB Micro-B, USB Mini-B, USB 3.0A, USB 3.0B, USB 3.0 Micro B, and USB Micro-AB. Further, a data communication protocol of USB4 is applied to communicate data using a USB-C connector, thereby providing a throughput of up to 40 Gbps, power delivery of up to 100 W, support for 4K and 5K displays, and backward compatibility with USB 3.2 and USB 2.

In some embodiments, the connectors 108 include a bidirectional channel for communicating a stream of data between the first and second electronic devices 102 and 104. The bidirectional channel of the connectors 108 include two data lanes and a pair of differential pins 110 coupled to the two data lanes. The pair of differential pins 110 is configured to receive a differential input signal from the first electronic device 102 or the second electronic device 104, and the differential input signal carries a serial data command or serial content data (e.g., video or audio data) that is communicated via the two data lanes of the connectors 108. As such, the two data lanes and pair of differential pins 110 of the connectors 108 are configured to facilitate bidirectional communication between the first electronic device 102 and the second electronic device 104. The bidirectional channel is a data channel or an auxiliary channel. Specifically, the auxiliary channel of the connectors 108 is used for communication of additional serial data beyond video and audio data, such as consumer electronics control (CEC) commands. In some embodiments, the pair of differential pins 110 is coupled to a dedicated set of twisted-pair wires configured to carry two input signals of the differential input signal.

Each connector 108 of the data link 106 is configured to be coupled to a respective connector 108 of the first electronic device 102 or a respective connector 108 of the second electronic device 104. Each connector 108 of the data link 106 is bidirectional, and so is each connector 108 of the electronic devices 102 and 104. When a connector 108 of the data link 106 is coupled to the first or second electronic device 102 or 104, the pair of differential pins 110 of the connector 108 of the data link 106 is physically and electrically coupled to a pair of differential pins 110 of the connector 108 of the first or second electronic device 102 or 104. The pair of differential pins 110 of the connector 108 of the first or second electronic device 102 or 104 is configured to receive data from, or transmit data to, the differential pins 110 of the connector 108 of the data link 106.

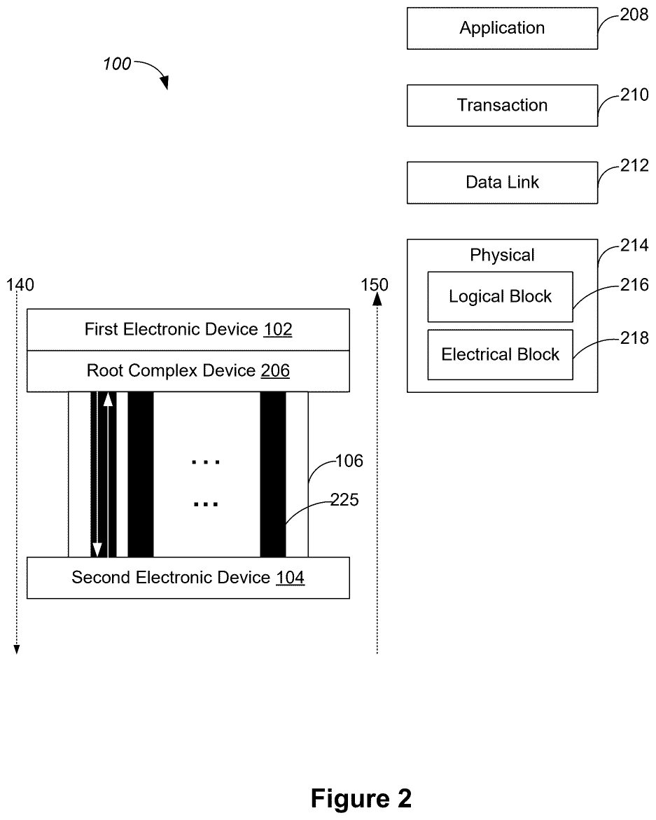

FIG. 2 is an example PCI Express electronic system 100 in which a first electronic device or component 102 is electrically coupled to a second electronic device or component 104 via a data link 106, in accordance with some embodiments. In an example, the first electronic device 102 includes a central processing unit (CPU) of a personal computer, and the second electronic device 104 is a peripheral component of the personal computer, such as a graphics card, a hard drive, a solid state drive, a Wi-Fi communication module, or an Ethernet card. The data link 106 includes a connection port for receiving from the second electronic device 104. The connection port is optionally formed on the mother board of the personal computer. The data link 106 complies with PCI Express (i.e., PCIe), which is a high-speed serial computer expansion bus standard, and provides an interface to communicate data packets between the first and second electronic devices 102 and 104 in compliance with the PCI Express. The data link 106 is a serial data bus including one or more data transmission channels 225. Each channel 225 includes two wire sets for transmitting and receiving data packets, thereby supporting full-duplex communication between the first and second electronic devices 102 and 104. In some examples, the data link 106 has 1, 4, 9, or 16 channels 225 coupled in a single data port of the data link 106. For each lane, the two wire sets correspond to a downstream data direction 140 or an upstream data direction 150 (defined with respect to the first electronic device 102). In some embodiments, each wire set includes two wires for carrying a pair of differential signals.

In some embodiments, the first electronic device 102 includes or is coupled to a root complex device 206 that is further coupled to the data link 106. The root complex device 206 is configured to generate requests for transactions including a series of one or more packet transmissions on behalf of the first electronic device 102. Examples of the transactions include, but are not limited to, Memory Read, Memory Read Lock, IO Read, IO Write, Configuration Read, Configuration Write, and Message. In some embodiments, the first electronic device 102 is coupled to one or more additional electronic devices besides the second electronic device 104. The data link 106 includes one or more switch devices to couple the root complex device 206 of the first electronic device 102 to multiple endpoints including the second electronic device 104 and additional electronic devices not shown in FIG. 1.

PCI Express is established based on a layered model including an application layer 208, a transaction layer 210, a data link layer 212, and a physical layer 214. As the top layer, the application layer 208 is implemented in software programs, such as Ethernet, NVMe, SOP, AHCI, and SATA. In the transaction layer 210, each transaction of a series of packet transmissions is implemented as requests and responses separated by time. For example, a memory-related transaction is translated to device configuration and control data transferred to or from the second electronic device 104 (e.g., a memory device). Data packets associated with each transaction are managed by data flows on the data link layer 212. The physical layer 214 of PCI Express controls link training and electrical (analog) signaling, and includes a logical block 216 and an electrical block 218. The logical block 216 defines ordered data sets in training states, and the electrical block 218 defines eye diagram characteristics and analog waveforms. Each layer of the layered model includes first specifications for a transmitting end where a root complex device 206 is coupled and second specifications for a receiving end where a peripheral component (i.e., the second electronic device 104) is coupled.

As high frequency signals are transmitted within the channels 225 of the data link 106, these signals are distorted and spread over sequential symbols and result in inter symbol interferences (ISI) and bit errors at the receiving end of the second electronic device 104. These ISI and bit errors can be suppressed by a feed-forward equalizer (FFE) that is coupled serially on a path of the data link 106 and configured with equalization settings using an equalization procedure. In an example, the FFE includes a finite impulse response (FIR) filter. The equalization procedure is implemented when a high-speed data transfer rate needs to be initialized, when an equalization request is issued from the application layer 208, or when a BER (bit error rate) exceeds a data error tolerance. In some embodiments, initiation and termination of the equalization procedure are detected on the physical layer 214 based on data packets transferred over the data link 106.

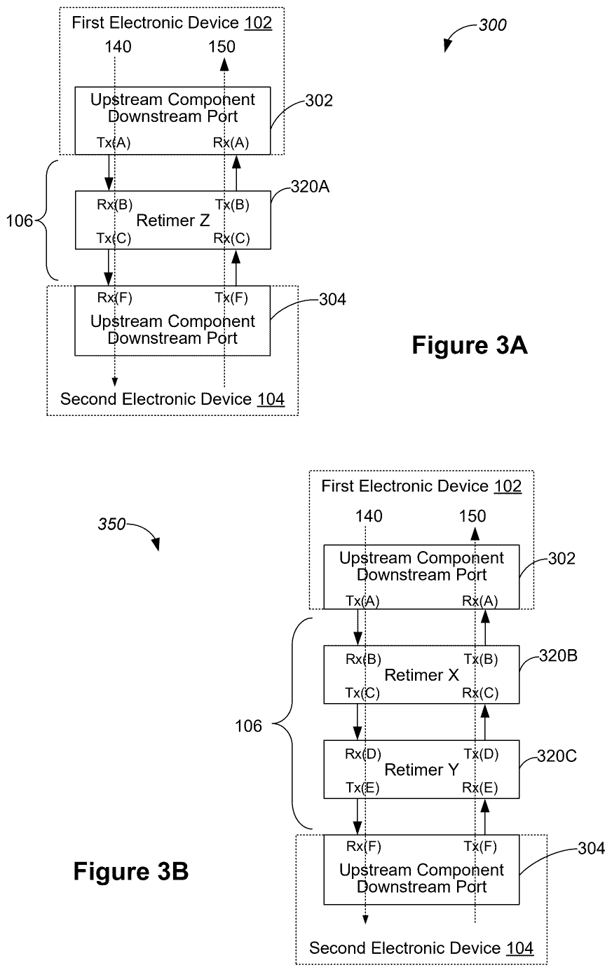

FIGS. 3A and 3B are two example electronic systems 300 and 350 in which a data link 106 is coupled between two electronic devices or components 102 and 104 and includes at least one retimer 320 (e.g., the retimers 320A, 320B, and 320C), in accordance with some embodiments. A retimer 320 is a mixed-signal device that is configured to transmit data packets actively (i.e., extract an embedded clock and recover the data packets in compliance with a bus standard, such as PCI Express). In an example, the retimer has a continuous time linear equalizer (CTLE), a wideband gain stage, and one or more of a clock and data recovery (CDR) circuit, a decision feedback equalizer (DFE), and a finite impulse response (FIR) driver. A state machine and/or a microcontroller is used in the retimer 320 to manage the CTLE, the wideband gain stage, the DFE, and the FIR driver, and implement a link training and status state machine (LTSSM).

The data link 106 enables bidirectional data communication between the electronic devices 102 and 104. A first electronic device 102 includes an upstream component 302 having a transmitting interface Tx(A) and a receiving interface Rx(A), and a second electronic device 104 includes a downstream component 304 having a receiving interface Rx(F) and a transmitting interface Tx(F). Each retimer 320 of the data link 106 is coupled between the electronic devices 102 and 104, and has a receiving interface Rx and a transmitting interface Tx for each of the downstream data direction 140 and the upstream data direction 150. Referring to FIG. 3A, the data link 106 includes only one retimer 320A. In some embodiments, the retimer 320A is disposed in proximity to the upstream component 302 of the first electronic device 102 or the downstream component 304 of the second electronic device 104. The receiving interface Rx(B) and the transmitting interface Tx(B) of the retimer 320A are coupled to the transmitting interface Tx(A) and receiving interface Rx(A) of the first electronic device 102, respectively. Another transmitting interface Tx(C) and another receiving interface Rx(C) of the retimer 320A are coupled to the receiving interface Rx(F) transmitting interface Tx(F) of the second electronic device 104, respectively. As such, data packets are transmitted between the electronic devices 102 and 104, either sequentially through the interfaces Tx(A), Rx(B), Tx(C), and Rx(F) on the downstream data direction 140 or sequentially through the interfaces Tx(F), Rx(C), Tx(B), and Rx(A) on the upstream data direction 150.

Referring to FIG. 3B, the data link 106 includes two retimers 320B and 320C that are electrically coupled in series between the first and second electronic devices 102 and 104. In an example, the first retimer 320B is disposed in proximity to the upstream component 302 of the first electronic device 102, and the second retimer 320C is disposed in proximity to the downstream component 304 of the second electronic device 104. A receiving interface Rx(B) and a transmitting interface Tx(B) of the first retimer 320B are coupled to the transmitting interface Tx(A) and receiving interface Rx(A) of the first electronic device 102, respectively. Another transmitting interface Tx(C) and another receiving interface Rx(C) of the first retimer 320B are coupled to a receiving interface Rx(D) and a transmitting interface Tx(D) of the second retimer 320C, respectively. Another transmitting interface Tx(E) and another receiving interface Rx(E) of the second retimer 320C are coupled to the receiving interface Rx(F) and transmitting interface Tx(F) of the second electronic device 104, respectively. As such, data packets are transmitted between the electronic devices 102 and 104, either sequentially through the interfaces Tx(A), Rx(B), Tx(C), Rx(D), Tx(E), and Rx(F) on the downstream data direction 140 or sequentially through the interfaces Tx(F), Rx(E), Tx(D), Rx(C), Tx(B), and Rx(A) on the upstream data direction 150.

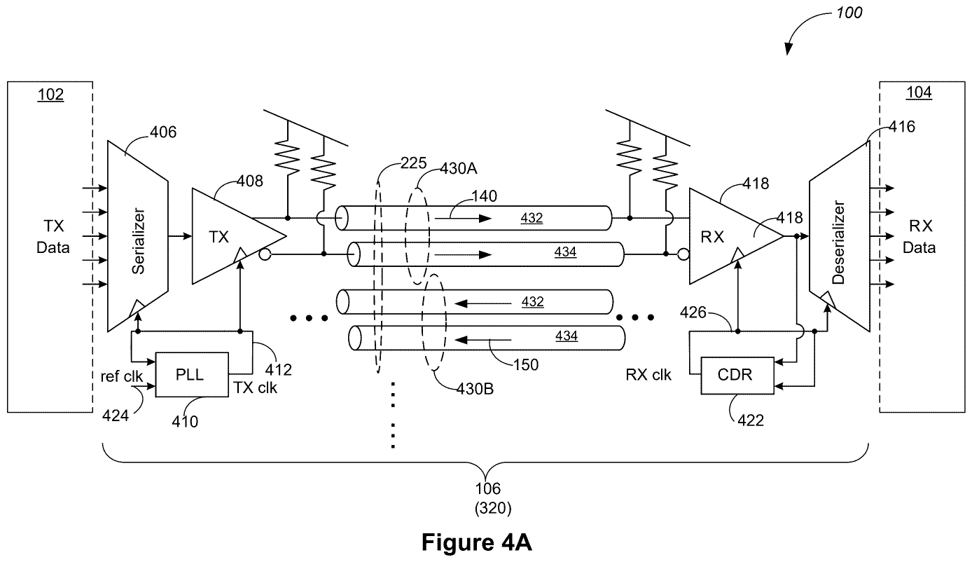

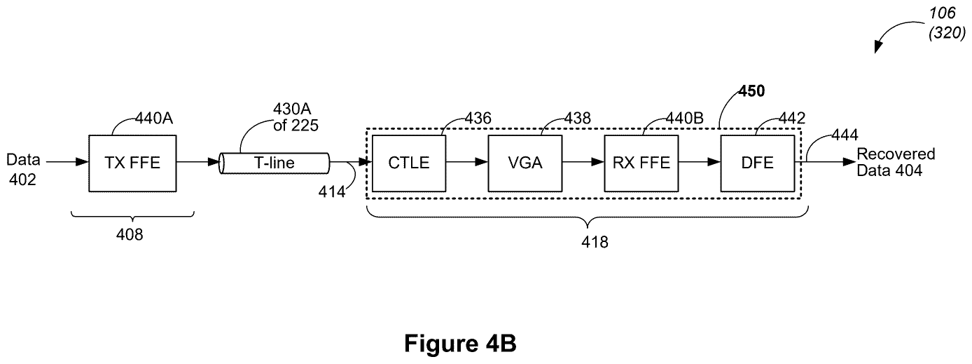

FIG. 4A is a block diagram of an example electronic system 100 in which a first electronic device or component 102 is electrically coupled to a second electronic device or component 104 via a data link 106, in accordance with some embodiments, and FIG. 4B is a block diagram of an example data link 106 including a plurality of modulation circuits 450, in accordance with some embodiments. In an example, the first electronic device 102 includes a central processing unit (CPU) of a personal computer, and the second electronic device 104 is a peripheral component of the personal computer, such as a graphics card, a hard drive, a solid state drive, a Wi-Fi communication module, or an Ethernet card. The data link 106 includes a connection port for receiving data from the second electronic device 104. The connection port is optionally formed on the mother board of the personal computer. In some embodiments, the data link 106 complies with a high-speed serial computer expansion bus standard (e.g., PCI Express (PCIe) or USB 4) and provides an interface to communicate data packets between the first and second electronic devices 102 and 104 in compliance with the bus standard. The data link 106 is a serial data bus including one or more data channels 225. In some embodiments, each data channel 225 includes two wire sets 430A and 430B (also called two data lanes) for transmitting and receiving data packets, respectively, thereby supporting full-duplex communication between the first and second electronic devices 102 and 104. In some examples, the data link 106 has 1, 4, 9, or 16 channels coupled in a single data port of the data link 106. For each data channel 225, the two wire sets 430A and 430B correspond to a downstream data direction 140 and an upstream data direction 150 defined with respect to the first electronic device 102, respectively. In some embodiments, each wire set 430A or 430B includes two respective wires 432 and 434 for carrying a pair of differential signals.

In some embodiments, the first electronic device 102 includes or is coupled to a root complex device (not shown) that is further coupled to the data link 106. The root complex device is configured to generate requests for transactions including a series of one or more packet transmissions on behalf of the first electronic device 102. Examples of the transactions include, but are not limited to, Memory Read, Memory Read Lock, Input Output (IO) Read, IO Write, Configuration Read, Configuration Write, and Message. In some embodiments, the first electronic device 102 is coupled to one or more additional electronic devices besides the second electronic device 104. The data link 106 includes one or more switch devices to couple the root complex device of the first electronic device 102 to multiple endpoints including the second electronic device 104 and additional electronic devices not shown in FIGS. 1 and 2.

A data transmission protocol (e.g., PCI Express, USB4 v2.0, or DisplayPort 2.1) is established based on a layered model including an application layer 208, a transaction layer 210, a data link layer 212, and a physical layer 214. As the top layer, the application layer 208 is implemented in software programs, such as Ethernet, NVMe, SOP, AHCI, and SATA. In the transaction layer 210, each transaction of a series of packet transmissions is implemented as requests and responses separated by time. For example, a memory-related transaction is translated to device configuration and control data transferred to or from the second electronic device 104 (e.g., a memory device). Data packets associated with each transaction are managed by data flows on the data link layer 212. The physical layer 214 controls link training and electrical (analog) signaling, and includes a logical block and an electrical block. The logical block 216 defines ordered data sets in training states, and the electrical block 218 defines eye diagram characteristics and analog waveforms. Each layer of the layered model includes first specifications for the transmitting side where a root complex device is coupled and second specifications for the receiving side where a peripheral component (i.e., the second electronic device 104) is coupled.

As signals are transmitted within the wire sets 430A and 430B of each data channel 225 of the data link 106, the signals are distorted and spread over sequential symbols. This results in inter symbol interferences (ISI) and bit errors at the receiving side of the second electronic device 104. In some embodiments, these ISI and bit errors can be suppressed by a feed-forward equalizer (FFE) that is coupled serially on a path of the data link 106 and configured with equalization settings using an equalization procedure. For example, an equalization procedure is implemented when a high-speed data transfer rate needs to be initialized, when an equalization request is issued from the application layer, or when the bit error rate (BER) exceeds the data error tolerance.

The electronic system 100 includes a serializer and deserializer (SERDES) system corresponding to the data link 106. The SERDES system of the data link 106 includes a serializer 406, a transmitter 408, the data channel 225, a receiver 418, and a deserializer 416. The serializer 406 converts parallel data received from the first electronic device 102 into serial data. The transmitter 408 sends the serial data to the data channel 225. The receiver 418 processes the serial data and sends the processed serial data to the deserializer 416, which converts the serial data back to the parallel data for the second electronic device 104. On the transmitting side, a phase lock loop 410 generates a transmitter clock signal 412 based on a reference clock signal 424, and the transmitter clock signal 412 is applied to control serialization of the data to be transmitted by the data channel 225 of the data link 106.

On the receiving side, a clock data recovery (CDR) circuit 422 is used to recover the receiver clock signal 426 from the serial data received via the data channel 225 and compensate for variation of signal amplitudes caused by loss and other factors in this data channel 225. In some embodiments, the CDR circuit 422 further includes a sampler and a clock recovery circuit. In some embodiments, the CDR circuit 422 is implemented based on one of: a phase-locked loop (PLL), a delay-locked loop (DLL), or a phase interpolator (PI). In some embodiments, the CDR circuit 422 satisfies a BER requirement corresponding to jitter tolerance. Additionally, the CDR circuit 422 complies with a communication interface standard (e.g., PCIe or USB4), is functional with spread spectrum clocking (SSC), and satisfies an electromagnetic interference (EMI) requirement. Under some circumstances, the CDR circuit 422 is configured to be applied in two or more data interfaces having different data rates and signal modulation schemes. The CDR circuit 422 is configurable (e.g., by offering a pull-in frequency range that is greater than a pull-in frequency range threshold and a jitter tolerance that is better than a jitter tolerance threshold). In some embodiments, the CDR circuit 422 is optimized in both of the pull-in frequency range and jitter tolerance.

The receiver clock signal 426 generated by the CDR 422 is used with the receiver 418 and the deserializer 416 to condition the serial data received via the data channel 225 and regenerate the parallel data from the serial data. During this process, the receiver 418 is configured to reduce (1) signal distortion, (2) data spreading over sequential symbols, (3) inter symbol interference (ISI), and (4) resulting bit errors of the serial data on the receiving side of the second electronic device 104. The receiver 418 is configured to generate an output data signal including the stream of data bits 402 in an input data signal of the receiver 418. In some embodiments, the receiver 418 includes a signal conditioning front end applying one or more modulation circuits 450 to compensate for loss from the data channel 225.

Referring to FIG. 4B, in some embodiments, the receiver 418 includes one or more of: a continuous time linear equalizer (CTLE) 436, a variable gain amplifier (VGA) 438, a feed-forward equalizer (FFE) 440B, and a decision feedback equalizer (DFE) 442. The CTLE 436 is configured to selectively attenuate low frequency signal components, amplify signal components around the Nyquist frequency, and remove higher frequency signal components to generate filtered serial data. Stated another way, in some embodiments, the CTLE 436 includes an analog filter designed to equalize the signal loss in certain frequencies. The VGA 438 has a variable gain. The DFE 442 is configured to further amplify the filtered serial data, and recover one or more data bits at each clock switching edge or during each clock cycle. The one or more recovered data bits form data packets. In some embodiments, the FFE 440B includes an FIR filter having a plurality of equalization settings (e.g., FIR coefficients), and is applied to improve signal quality of the data packets via digital signal conditioning (e.g., via high frequency filtering in a digital domain). In some embodiments, feed forward equalization is performed by a transmitter-side FFE 440A, a receiver-side FFE 440B, or both. The transmitter-side FFE 440A is configured to pre-distort the signal to compensate for the lossy data channel 225. In some embodiments, a subset or all of the modulation circuits 450 are applied, and the order of the modulation circuits 450 is optionally identical to or distinct from that shown in FIG. 4B. As such, the receiver 418 receives an input data signal 414 carrying a stream of data bits 402 according to a reference clock frequency (e.g., the reference clock signal 424 in FIG. 4A), and outputs an output data signal 404 including a stream of recovered data bits 404 that is consistent with the stream of data bits 402, thereby reliably keeping the stream of data bits 402 in the input data signal 414.

In some embodiments of this application, in-situ adaptation is implemented on different modulation circuits 450 of an electronic device (e.g., at a second electronic device 104 in FIG. 1). The electronic device includes a sequence of modulation circuits 450, and each modulation circuit has one or more adjustable configurations. The electronic device obtains an input data signal 414. The sequence of modulation circuits 450 processes the input data signal 414 and generates an equalized data signal 444 including a first data sample. The electronic device determines the first residual error of the first data sample, and adjusts the first adjustable configuration of the first modulation circuit (e.g., the CTLE 436) based on the first residual error. A second adjustable configuration of a second modulation circuit (e.g., the VGA 438) is further adjusted based on the first adjustable configuration. In some embodiments, a single receiver integrated circuit (IC) includes the sequence of modulation circuits 450 and is configured to operate with different data rates, ambient temperatures, protocols, cables, and operating environments. Each modulation circuit 450 of the receiver 418 is highly programmable and adaptive to offer different equalizer strengths and configurations in support of highly variable operating conditions. In-situ and real-time adaptations of the modulation circuits 450 are implemented dynamically, jointly, and iteratively without interfering with each other. As the operating conditions (e.g., ambient temperature) change in real time during operation, in-situ and real-time adaptation of the receiver 418 makes the data communication link 106 transmit data reliably and adjustably in response to variations of the operating conditions.

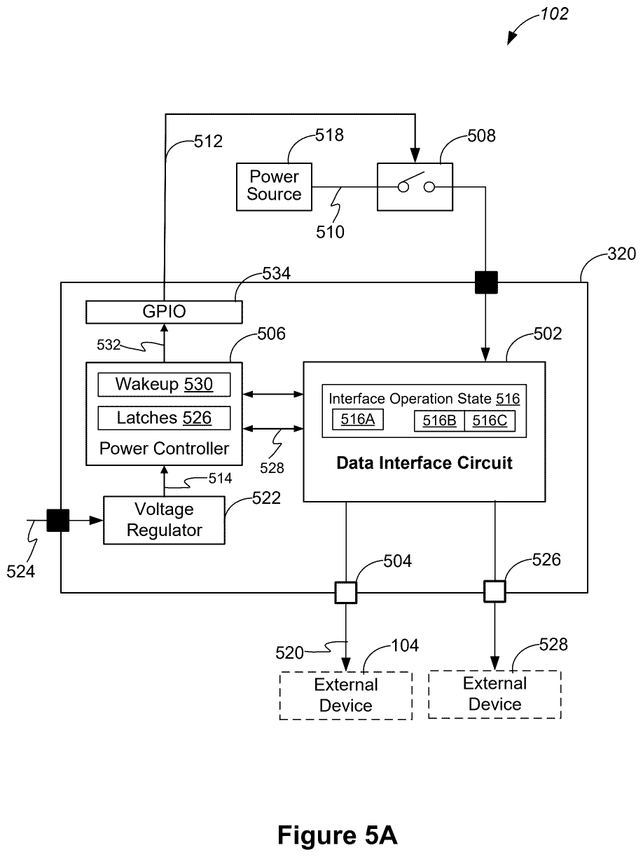

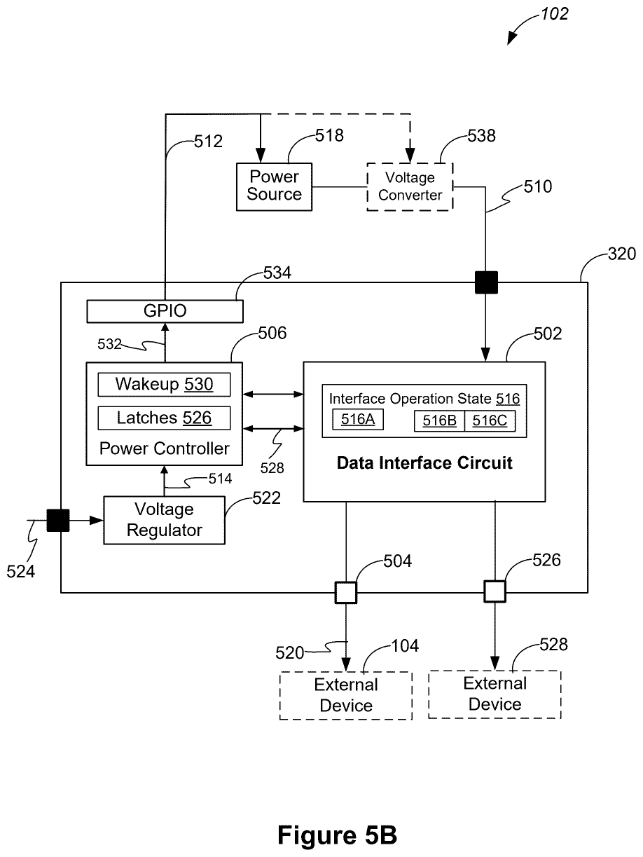

FIGS. 5A and 5B are block diagrams of two example electronic devices 102 that control power consumption of a data interface circuit 502, in accordance with some embodiments. The electronic device 102 includes a data port 504 for coupling the electronic device 102 to an external device 104, the data interface circuit 502 coupled to the data port 504, and a power controller 506 coupled to the data interface circuit 502. The data interface circuit 502 is configured to receive a first power signal 510 provided based on an interface power control signal 512 and exchange data with the external device 104 coupled via the data port 504. The power controller 506 is configured to receive a second power signal 514, monitor an interface operation state 516 of the data interface circuit 502, and generate the interface power control signal 512 based on the interface operation state 516. The second power signal 514 is distinct from the first power signal 510. In some embodiments, the data interface circuit 502 is a core module of a retimer 320 (FIGS. 3, 4A, and 4B). Alternatively, in some embodiments, the data interface circuit 502 and the power controller 506 are both included in the retimer 320.

In some embodiments, the interface operation state 516 includes an active operation state 516A in which the communication bus 520 is mechanically coupled to the data port 504 with the external device 104 and data has been exchanged via the data port 504 within a predefined time duration (e.g., during the past five minutes). Further, in some embodiments, in accordance with a determination that the data interface circuit 502 has the active operation state 516A, the power controller 506 sets the interface power control signal 512 to enable the first power signal 510 to power the data interface circuit 502. In other words, the communication bus 520 is applied actively to exchange data between the electronic device 102 and the external device 104, and the data interface circuit 502 is powered by the first power signal 510, such that the data can be properly generated, received, or processed via the data interface circuit 502.

In some embodiments, the interface operation state 516 includes one of a first low power state 516B and a second low power state 516C. In the first low power state 516B, no communication bus is mechanically coupled to the data port 504, or a communication bus 520 is mechanically coupled to the data port 504 without being connecting to the external device 104. In the second low power state 516C, the communication bus 520 is mechanically coupled to the data port 504 with the external device 104, and no data has been exchanged via the data port for at least a predefined time duration (e.g., during the past five minutes). Further, in some embodiments, in accordance with a determination that the data interface circuit 502 has the first low power state 516B or the second low power state 516C, the power controller 506 sets the interface power control signal 512 to disable the first power signal 510 from powering the data interface circuit 502. In some embodiments, the first power signal 510 is disabled from powering the data interface circuit in both the first low power state 516B and the second low power state 516C.

Referring to FIG. 5A, in some embodiments, the electronic device 102 further includes a switch component 508 electrically coupled to a power source 518 and the data interface circuit 502. The power controller 506 is configured to control the switch component 508 using the interface power control signal 512 to provide the first power signal 510. In an example, the switch component 508 includes a single transistor. In another example, the switch component 508 includes a transmission gate in which a P-type transistor and an N-type transistor are coupled in parallel with their drain terminals connected to each other and with their source terminals connected to each other. Further, in some embodiments, the power source 518 generates the first power signal 510. The interface power control signal 512 is a digital signal having a first voltage level (e.g., corresponding to “0”) and a second voltage level (e.g., corresponding to “1”). For example, one of the first and second voltage levels may turn on the switch component 508, allowing the first power signal 510 generated by the power source 518 to power the data interface circuit 502, and conversely, the other one of the first and second voltage levels may turn off the switch component 508, disabling the first power signal 510 from powering the data interface circuit 502. When the switch component 508 is turned on or enabled, a switch resistance of the switch component 508 is lower than a first threshold switch resistance R_{TH1}, and the power source 518 is electrically coupled to the data interface circuit 502. When the switch component 508 is turned off or disabled, a switch resistance of the switch component 508 is greater than a second threshold switch resistance R_{TH2} (e.g., equal to 10³R_{TH1}), and the power source 518 is electrically decoupled from the data interface circuit 502.

In some embodiments, the interface power control signal 512 has a first voltage level (e.g., corresponding to “0”) and is disabled, independently of whether a communication bus 520 or the external device 104 is coupled to the data port 504, when no data has been exchanged via the data port 504 for at least a predefined time duration. The power controller 506 provides the interface power control signal 512 to disable the switch component 508 from passing the first power signal 510 and powering the data interface circuit 502. Conversely, in some embodiments, the interface power control signal 512 has a second voltage level (e.g., corresponding to “1”) and is enabled, when data has been exchanged via the data port 504 within the predefined time duration (e.g., 5 minutes). The power controller 506 provides the interface power control signal 512 to enable the switch component 508 to let the first power signal 510 pass to power the data interface circuit 502.

Stated another way, in some embodiments, a retimer 320 includes a core module (e.g., data interface circuit 502) and a control unit (e.g., power controller 506). The core module is configured for initiating communication on a mainlink. The control unit is constantly powered on and configured to provide a power control signal (e.g., interface power control signal 512). The core module of the retirmer is controlled by the power control signal to enable or disable operations of the core circuit. Further, in some embodiments, the retimer 320 includes a switch component 508 in addition to the core module and the control unit. The control unit is constantly powered on and configured to provide the power control signal, and the switch component 508 is controlled by the power control signal to enable the core circuit to be coupled to a power supply (e.g., power source 518) or disable the core circuit from being coupled to the power supply.

Referring to FIG. 5B, in some embodiments, the power source 518 is electrically coupled and configured to the data interface circuit 502 without any switch component 508. Instead, the power controller 506 is configured to control (e.g., enable and disable) the power source 518 using the interface power control signal 512 to provide the first power signal 510. One of the first and second voltage levels of the interface power control signal 512 may enable the power source 518 to provide the first power signal 510 to power the data interface circuit 502, and conversely, the other one of the first and second voltage levels may disable the power source 518 from providing the first power signal 510. Alternatively and additionally, in some embodiments, the electronic device 102 further includes a DC-DC voltage converter 538 coupled between the power source 518 and the data interface circuit 502. The power controller 506 is configured to control (e.g., enable and disable) the voltage converter 538 using the interface power control signal 512 to provide the first power signal 510. One of the first and second voltage levels of the interface power control signal 512 may enable the voltage converter 538 to provide the first power signal 510 to power the data interface circuit 502, and conversely, the other one of the first and second voltage levels may disable the voltage converter 538 from providing the first power signal 510.

In some embodiments, the switch component 508 (FIG. 5A) or the voltage converter 538 (FIG. 5B) is external to the re-timer 320, allowing filter capacitors having relatively large sizes to be applied to reduce ripples in the first power signal 510.

In some embodiments, the second power signal 514 is generated by a voltage regulator 522 powered by a power supply signal 524. In an example, the voltage regulator 522 includes a low dropout (LDO) regulator, and a voltage difference between the power supply signal 524 and the second power signal 514 is substantially small (e.g., less than 0.2 V). In some embodiments, the voltage regulator 522 is constantly powered by the power supply signal 524 to generate the second power signal 514, so is the power controller 506 constantly powered by the second power signal 514, independently of whether the data interface circuit is disabled from being powered by the power source 518. Stated another way, in some embodiments, when the electronic device 102 is electrically coupled to mains electricity (e.g., utility power, grid power, domestic power, and wall power), the second power signal 514 is enabled to power the power controller 506, so is the power supply signal 524 available to power the voltage regulator 522 to provide the second power signal 514.

Under some circumstances (e.g., when no data has been exchanged via the data port 504 for at least a predefined time duration), the interface power control signal 512 disables the power source 518 from powering the data interface circuit 502. The data interface circuit 502 is not powered by the first power signal 510, and only the voltage regulator 522 and the power controller 506 are powered by the power supply signal 524 to generate the interface power control signal 512, thereby conserving power consumption of the retimer 320.

In some embodiments, the power controller 506 includes a plurality of latches 536 configured to hold one or more state signals 528 corresponding to the interface operation state 516, before and while the first power signal 510 is disabled from powering the data interface circuit 502 based on the interface power control signal 512. Stated another way, the plurality of latches 536 are configured to store values of registers in the data interface circuit 502, when the first power signal 510 is disabled from powering the data interface circuit 502. Further, in some embodiments, the data interface circuit 502 includes one or more of a CTLE 436, a VGA 438, a FFE 440B, and a DFE 442 of a plurality of modulation circuits 450 of a retimer 320 (FIG. 4B). The one or more state signals 528 include one or more of a plurality of filter coefficients applied in the data interface circuit 502 (e.g., the FFE 440B) and a gain of an amplifier (e.g., the VGA 438) applied in the data interface circuit 502. Additionally, in some embodiments, when the data interface circuit 502 switches from the first or second low power state 516B or 516C to the active operation state 516A, the one or more state signals 528 held by the plurality of latches 536 are provided to restore settings (e.g., the filter coefficients, the amplifier gain) of the data interface circuit 502.

In some embodiments, the data port 504 is configured to support data communication via a serial data bus. Further, in some embodiments, the data port 504 is configured to support data communication according to a peripheral component interconnect express (PCIe) protocol, a universal serial bus (USB) protocol, a high-definition multimedia interface (HMDI) protocol, a DisplayPort (DP) protocol, a Thunderbolt protocol, an inter-integrated circuit (I2C) protocol, or a serial advanced technology attachment (SATA) protocol. In some embodiments, the data interface circuit 502 is included in a retimer 320 configured to compensate for an insertion loss of the serial data bus. Alternatively, in some embodiments not shown, the data interface circuit 502 is included in a redriver configured to amplify a data signal transmitted on the serial data bus. Further, in some embodiments, the power controller 506 includes a plurality of latches 536 configured to hold one or more state signals 528 corresponding to a gain of an amplifier applied in the redriver.

In some embodiments, the data port 504 includes a first data port for receiving a first external device. The electronic device 102 further includes one or more alternative ports 526 coupled to the data interface circuit 502. The interface operation state 516 is associated with the data interface circuit 502, the first data port 504, and the one or more alternative ports 526, and applied to generate the interface power control signal 512 for controlling the first power signal 510 provided to power the data interface circuit 502. For example, the interface operation state 516 is one of the active operation state 516A, the first low power state 516B, and the second low power state 516C. The data interface circuit 502 has the active operation state 516A when data has been exchanged via any of the data port 504 and the one or more alternative ports 526 within a predefined time duration (e.g., 5 minutes).

In some embodiments, the first data port 504 and the one or more alternative ports 526 have the same type of data port configured to communicate data in compliance with a first data communication protocol (e.g., PCIe). Alternatively, in some embodiments, at least two of the first data port 504 and the one or more alternative ports 526 include different types of data ports configured to communicate data in compliance with two different data communication protocols.

Referring to FIG. 5A, in some embodiments, the power controller 406 further includes a wakeup circuit 530 coupled to the data ports 504 and 526. The wakeup circuit 530 is configured to monitor the data ports 504 and 526 and generate a wakeup signal 532 indicating whether there are data passing the data ports 504 and 526, e.g., there is a transmission signal on communication protocol interfaces including DP, HDMI, USB, and I2C within a predefined time duration such as the past five minutes. The wakeup signal 532 is outputted as the interface power control signal 512 via a general-purpose input/output (GPIO) pin 534. In some embodiments, the wakeup circuit 530 is constructed with a reset-set (RS) latch having two cross-coupled NOR gates or NAND gates. In some embodiments, the power controller 506 and the GPIO pin 534 are powered in an IO voltage domain associated with the power supply signal 524, thereby enabling the retimer 320 to utilize the IO voltage domain to regulate its entry into a low power mode (e.g., including the first low power state 516B and the second low power state 516C).

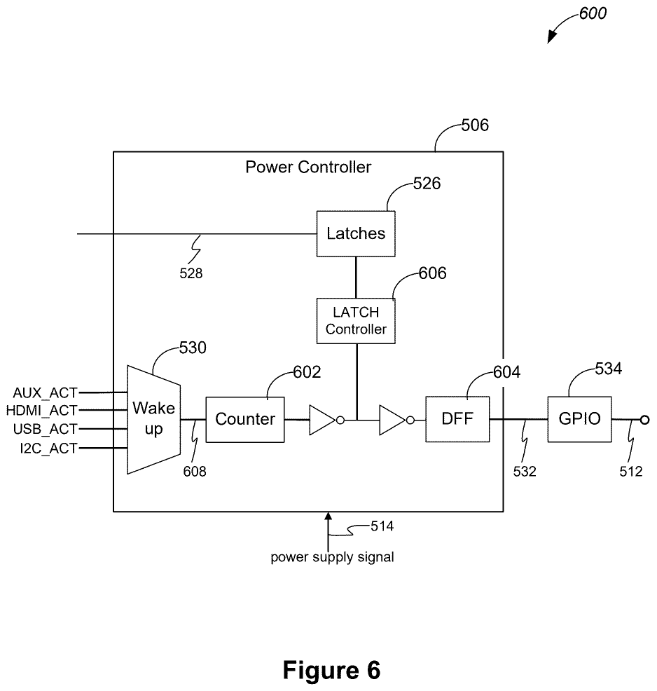

FIG. 6 is a block diagram of an example power controlling system 600 applied to control a first power signal 510 of a data interface circuit 502, in accordance with some embodiments. The power controlling system 600 includes a power controller 506 and a GPIO pin 534, and enables a retimer 320 to utilize an IO voltage domain powered by a power supply signal 524 to enter into its associated low power states 516B and 516C. The first low power state 516B occurs when no communication bus is mechanically coupled to the data port 504 or when a communication bus 520 is mechanically coupled to the data port 504 without being connecting to the external device 104. The second low power state 516C occurs when the communication bus 520 is mechanically coupled to the data port 504 with the external device 104 and no data has been exchanged via the data port for at least a predefined time duration (e.g., 5 minutes). In some embodiments, the power controlling system 600 monitors whether there is any data passing through available data ports of the retimer 320 (e.g., data ports 504 and 526 in FIGS. 5A and 5B) to determine whether to enable the first power signal 510 to power the data interface circuit 502.

In some embodiments, the power controller 506 of the power controlling system 600 includes a wakeup circuit 530, a counter 602, a data flip flop (DFF) 604, a latch controller 606, a plurality of latches 536. The wakeup circuit 530 monitors one or more communication protocol interfaces (e.g., DP, HDMI, USB, and I2C) associated with the retimer 320, and generate a data status signal 608 indicating whether there are transmission signals passing the communication protocol interfaces (e.g., data ports 504 and 526 in FIGS. 5A and 5B) in real time. The counter 602 is coupled to the wakeup circuit 530, and configured to measure a length of a time duration for which a state of the data status signal 608 lasts.

In some embodiments, a first state of the data status signal 608 corresponds to no data transmission at the data ports 504 and 526, and is sustained for a predefined time duration (e.g., five minutes) before the low power mode (e.g., low power states 516B and 516C) is enabled for the data interface circuit 502. Stated another way, in accordance with a determination that the first state of the data status signal 608 lasts for the predefined time duration, the latch controller 606 controls the latches 536 to hold one or more state signals 528 corresponding to the interface operation state 516, and the DFF 604 outputs a wakeup signal 532 indicating that there is no data passing the data ports 504 and 526 for the predefined time duration. The GPIO pin 534 further provides the interface power control signal 512 based on the wakeup signal 532.

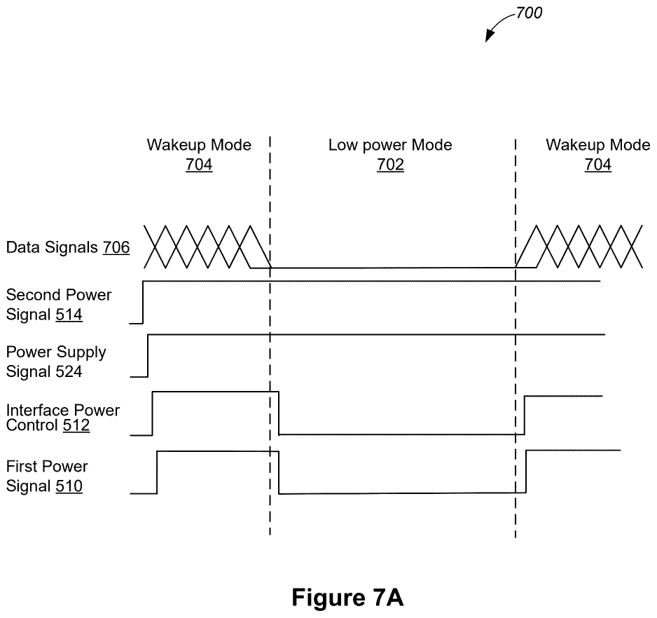

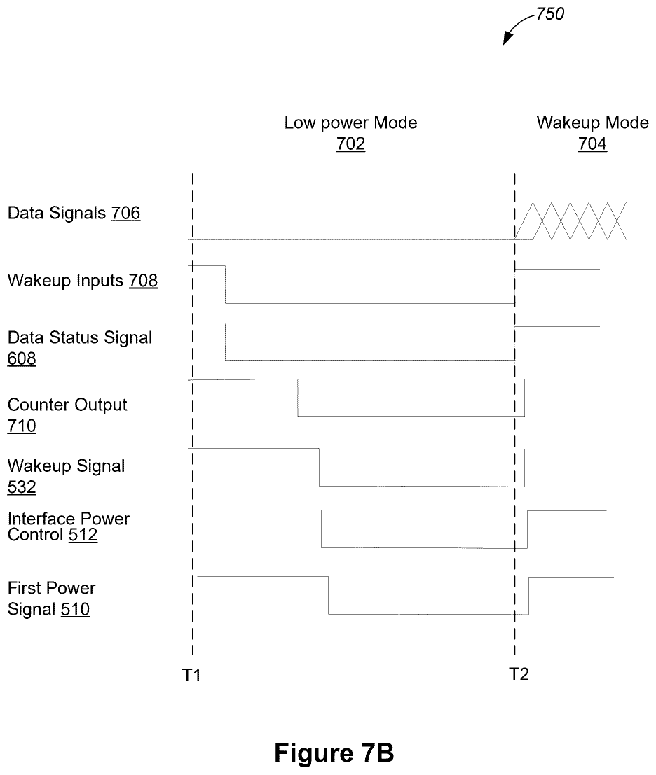

FIG. 7A is a temporal diagram of example voltage signals 700 of an electronic device 102 having a data interface circuit 502 that alternates between a low power mode 702 and a wakeup mode 704, in accordance with some embodiments. The data interface circuit 502 starts with the wakeup mode 704, switches to the low power mode 702, and returns to the wakeup mode 704. The wakeup mode 704 includes an active operation state 516A in which a first power signal 510 is enabled to power the data interface circuit 502, and the low power mode 702 includes low power states 516B and 516C in which no data is transmitted via data ports coupled to a retimer 320 and the first power signal 510 is disabled from powering the data interface circuit 502.

After the wakeup mode 704 is initially started, one or more data signals 706 are communicated via the data port 504 or 526. A power supply signal 524 is initiated and used to generate a second power signal 514 in an IO voltage domain, and subsequently, the power supply signal 524 and the second power signal 514 are constantly enabled, independently of the wakeup mode 704 and the low power mode 702. The interface power control signal 512 is enabled in the wakeup mode 704, thereby enabling the first power signal 510 to power the data interface circuit 502. When the data signals 706 stop (e.g., for the predefined time duration), the interface power control signal 512 is disabled in the low power mode 702, thereby disabling the first power signal 510 from powering the data interface circuit 502 and conserving power consumption of the data interface circuit 502. When the data signals 706 restarts in the wakeup model 704, the interface power control signal 512 is enabled, so is the first power signal 510. As such, the interface power control signal 512 generated by the power controller 506 facilitates seamless access to the lower power mode 702.

FIG. 7B is a temporal diagram of example voltage signals 750 of an electronic device 102 having a data interface circuit 502 that switches from a low power mode 702 to a wakeup mode 704, in accordance with some embodiments. The data interface circuit 502 is coupled to a power controlling system 600. The voltage signals 750 include one or more signals of the power controlling system 600, e.g., one or more wakeup inputs 708 received at a wakeup circuit 530 (FIG. 6), a data status signal 608 generated by the wakeup circuit 530, a counter output 710 generated by a counter 602, a wakeup signal 532 outputted by a DFF 604, and an interface power control signal 512 provided by a GPIO pin 534.

In some embodiments, the low power mode 702 may be associated with a first time T1 when the data signals 706 stops transmitting data. The wakeup inputs 708 is disabled with a delay from the first time T1, and the data status signal 608 is disabled with a delay from the wakeup inputs 708. The counter output 710 is further delayed with respect to the data status signal 608, e.g., by the predefined time duration. The wakeup signal 532 is further disabled with a delay with respect to the counter output 710, and the interface power control signal 512 is disabled with a delay with respect to the wakeup signal 532. The first power signal 510 is disabled with a delay with respect to the interface power control signal 512.

In some embodiments, the wakeup mode 704 is initiated at a second time T2 when data are transmitted with the data signals 706 via the data port 504 or 526. The wakeup inputs 708, the data status signal 608, the counter output 710, the wakeup signal 532, the interface power control signal 512, and the first power signal 510 are successively enabled. Particularly, the counter output 710 may be delayed with respect to the data status signal 608 without the predefined time duration.

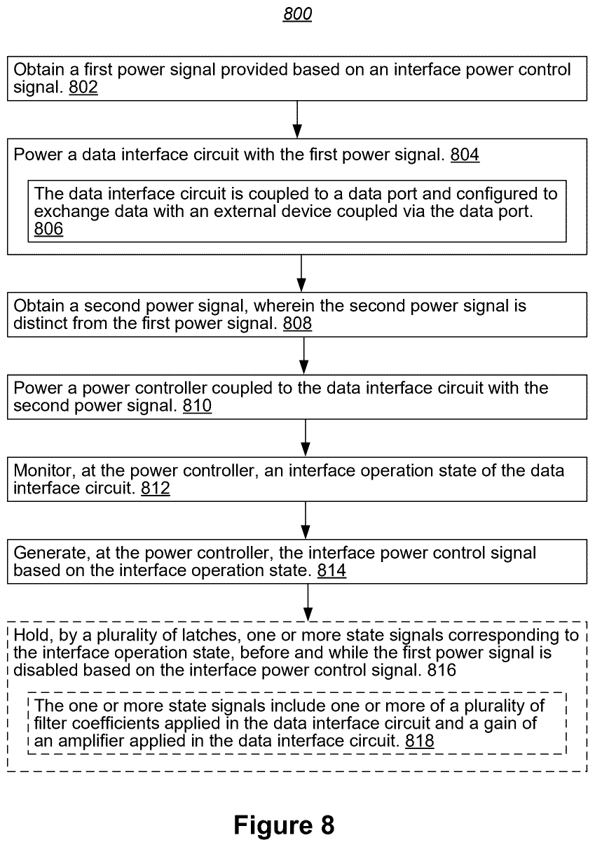

FIG. 8 is a flow diagram of an example method 800 for controlling power consumption of a data interface circuit 502 of an electronic device 102, in accordance with some embodiments. The data interface circuit 502 obtains (operation 802) a first power signal 510 provided based on an interface power control signal 512, and is powered (operation 804) with the first power signal 510. The data interface circuit 502 is coupled (operation 806) to a data port 504 and configured to exchange data with an external device 104 coupled via the data port 504. A second power signal 514 is distinct (operation 808) from the first power signal 510 and is obtained to drive a power controller 406. The power controller 506 is coupled to the data interface circuit 502 and powered (operation 810) with the second power signal 514. The power controller monitors (operation 812) an interface operation state 516 of the data interface circuit 502 and generates (operation 814) the interface power control signal 512 based on the interface operation state 516.

In some embodiments, the power controller 506 includes a plurality of latches 536, and the plurality of latches 536 holds (operation 816) one or more state signals 528 corresponding to the interface operation state 516, before and while the first power signal 510 is disabled based on the interface power control signal 512. Further, in some embodiments, the one or more state signals 528 include (operation 818) one or more of a plurality of filter coefficients applied in the data interface circuit 502 and a gain of an amplifier (e.g., VGA 438 in FIG. 4B) applied in the data interface circuit 502.

In some embodiments, the data port 504 supports data communication via a serial data bus (e.g., communication bus 520 in FIGS. 5A and 5B), and the data interface circuit 502 includes a redriver configured to amplify a data signal transmitted on the serial data bus or a retimer 320 configured to compensate for an insertion loss of the serial data bus.

In some embodiments, the data port 504 is configured to support data communication via a serial data bus (e.g., communication bus 520 in FIGS. 5A and 5B) according to a peripheral component interconnect express (PCIe) protocol, a universal serial bus (USB) protocol, a high-definition multimedia interface (HMDI) protocol, a DisplayPort protocol, a Thunderbolt protocol, an inter-integrated circuit (I2C) protocol, or a serial advanced technology attachment (SATA) protocol.

In some embodiments, the interface operation state 516 includes one of a first low power state 516B and a second low power state 516C. In some situations, the power controller 506 506 determines that no communication bus is mechanically coupled to the data port 504 or a communication bus 520 is mechanically coupled to the data port 504 without being connecting to the external device 104, thereby detecting the first low power state 516B. Alternatively, in some situations, the power controller 506 506 determines that the communication bus 520 is mechanically coupled to the data port 504 with the external device 104 and no data has been exchanged via the data port 504 for at least a predefined time duration, thereby detecting the second low power state 516C. Further, in some embodiments, the power controller 506 generates the interface power control signal 512 based on the interface operation state 516 by, in accordance with a determination that the data interface circuit 502 has the first low power state 516B or the second low power state 516C, setting the interface power control signal 512 to disable the first power signal 510 from powering the data interface circuit 502.

In some embodiments, the interface operation state 516 includes an active operation state 516A in which the communication bus 520 is mechanically coupled to the data port 504 with the external device 104 and data has been exchanged via the data port 504 within a predefined time duration. Additionally, in some embodiments, the power controller 506 generates the interface power control signal 512 based on the interface operation state 516 by, in accordance with a determination that the data interface circuit 502 has the active operation state 516A, setting the interface power control signal 512 to enable the first power signal 510 to power the data interface circuit 502.

In some embodiments, the data port 504 includes a first data port for receiving a first external device 104, and the electronic device 102 further includes one or more alternative ports 526 coupled to the data interface circuit 502. The interface operation state 516 is associated with the data interface circuit 502, the first data port 504, and the one or more alternative ports 526, and applied to generate the interface power control signal 512 for controlling the first power signal 510 provided to power the data interface circuit 502. Further, in some embodiments, the first data port 504 and the one or more alternative ports 526 have the same type of data port configured to communicate data in compliance with a first data communication protocol. Conversely, in some embodiments, at least two of the first data port 504 and the one or more alternative ports 526 include different types of data ports configured to communicate data in compliance with two different data communication protocols.

In some embodiments, when the electronic device 102 is electrically coupled to mains electricity, the second power signal 514 is enabled to power the power controller 506.

In some embodiments, a switch component 508 electrically coupled to a power source 518 and the data interface circuit 502, and the power controller 506 controls the switch component 508 using the interface power control signal 512 to provide the first power signal 510. Further, in some embodiments, the power controller 506 disables the power source 518 from powering the data interface circuit 502 when no data has been exchanged via the data port 504 for at least a predefined time duration, independently of whether a communication bus 520 or the external device 104 is coupled to the data port 504. The power controller 506 enables the power source 518 to power the data interface circuit 502 when data has been exchanged via the data port 504 within the predefined time duration.

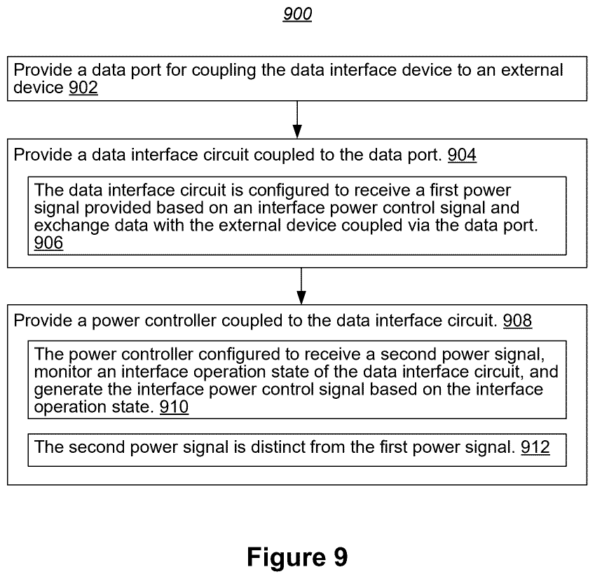

FIG. 9 is a flow diagram of an example method 900 for providing a data interface circuit 502 of an electronic device 102, in accordance with some embodiments. The method 900 includes providing (operation 902) a data port 504 for coupling the data interface circuit 502 to an external device 104 and providing (operation 904) the data interface circuit 502 coupled to the data port 504. The data interface circuit 502 is configured (operation 906) to receive a first power signal 510 provided based on an interface power control signal 512 and exchange data with the external device 104 coupled via the data port 504. The method 900 further includes providing (operation 908) a power controller 506 coupled to the data interface circuit 502. The power controller 506 is configured (operation 910) to receive a second power signal 514, monitor an interface operation state 516 of the data interface circuit 502, and generate the interface power control signal 512 based on the interface operation state 516. The second power signal 514 is distinct (operation 912) from the first power signal 510.

It should be understood that the particular order in which the operations in FIG. 8 or 9 have been described are merely exemplary and are not intended to indicate that the described order is the only order in which the operations could be performed. One of ordinary skill in the art would recognize various ways to enhance speech quality. Additionally, it should be noted that details of other processes described above with respect to FIGS. 1-7B are also applicable in an analogous manner to methods 800 and 900 described above with respect to FIGS. 8 and 9. For brevity, these details are not repeated here.

It will also be understood that, although the terms first and second are used, in some instances, to describe various elements, these elements are not limited by these terms. These terms are only used to distinguish one element from another. For example, a first electronic device can be termed a second electronic device, and, similarly, a second electronic device can be termed a first electronic device, without departing from the scope of the various described embodiments. The first electronic device and the second electronic device are both electronic devices, but they are not the same electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” means “when” or “upon” or “in response to determining” or “in response to detecting” or “in accordance with a determination that,” depending on the context. Similarly, the phrase “if it is determined” or “if [a stated condition or event] is detected” means “upon determining” or “in response to determining” or “upon detecting [the stated condition or event]” or “in response to detecting [the stated condition or event]” or “in accordance with a determination that [a stated condition or event] is detected,” depending on the context.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software, or any combination thereof.

The above description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. An electronic device, comprising:
a data port for coupling the electronic device to an external device;
a data interface circuit coupled to the data port, the data interface circuit configured to receive a first power signal provided based on an interface power control signal and exchange data with the external device coupled via the data port; and
a power controller coupled to the data interface circuit, the power controller configured to receive a second power signal, monitor an interface operation state of the data interface circuit, and generate the interface power control signal based on the interface operation state, wherein the second power signal is distinct from the first power signal.

2. The electronic device of claim 1, wherein the power controller includes a plurality of latches configured to hold one or more state signals corresponding to the interface operation state, before and while the first power signal is disabled based on the interface power control signal.

3. The electronic device of claim 2, wherein the one or more state signals include one or more of:
a plurality of filter coefficients applied in the data interface circuit; and
a gain of an amplifier applied in the data interface circuit.

4. The electronic device of claim 1, wherein the data port is configured to support data communication via a serial data bus, and the data interface circuit includes a redriver configured to amplify a data signal transmitted on the serial data bus or a retimer configured to compensate for an insertion loss of the serial data bus.

5. The electronic device of claim 1, wherein the data port is configured to support data communication via a serial data bus according to a peripheral component interconnect express (PCIe) protocol, a universal serial bus (USB) protocol, a high-definition multimedia interface (HMDI) protocol, a DisplayPort protocol, a Thunderbolt protocol, an inter-integrated circuit (I2C) protocol, or a serial advanced technology attachment (SATA) protocol.

6. The electronic device of claim 1, wherein the interface operation state includes one of:
a first low power state in which no communication bus is mechanically coupled to the data port or a communication bus is mechanically coupled to the data port without being connecting to the external device; and
a second low power state in which the communication bus is mechanically coupled to the data port with the external device and no data has been exchanged via the data port for at least a predefined time duration.

7. The electronic device claim 6, wherein the power controller is configured to generate the interface power control signal based on the interface operation state by:
in accordance with a determination that the data interface circuit has the first low power state or the second low power state, setting the interface power control signal to disable the first power signal from powering the data interface circuit.

8. The electronic device of claim 1, wherein the interface operation state includes an active operation state in which the communication bus is mechanically coupled to the data port with the external device and data has been exchanged via the data port within a predefined time duration.

9. The electronic device claim 8, wherein the power controller is configured to generate the interface power control signal based on the interface operation state by:
in accordance with a determination that the data interface circuit has the active operation state, setting the interface power control signal to enable the first power signal to power the data interface circuit.

10. The electronic device of claim 1, wherein the data port includes a first data port for receiving a first external device, the electronic device further comprising:
one or more alternative ports coupled to the data interface circuit;
wherein the interface operation state is associated with the data interface circuit, the first data port, and the one or more alternative ports, and applied to generate the interface power control signal for controlling the first power signal provided to power the data interface circuit.

11. The electronic device of claim 10, wherein the first data port and the one or more alternative ports have the same type of data port configured to communicate data in compliance with a first data communication protocol.

12. The electronic device of claim 10, wherein at least two of the first data port and the one or more alternative ports include different types of data ports configured to communicate data in compliance with two different data communication protocols.

13. The electronic device of claim 1, wherein when the electronic device is electrically coupled to mains electricity, the second power signal is enabled to power the power controller.

14. The electronic device of claim 1, further comprising a switch component electrically coupled to a power source and the data interface circuit, and the power controller is configured to control the switch component using the interface power control signal to provide the first power signal.

15. The electronic device of claim 14, wherein the power controller is configured to:
disable the power source from powering the data interface circuit when no data has been exchanged via the data port for at least a predefined time duration, independently of whether a communication bus or the external device is coupled to the data port; and
enable the power source to power the data interface circuit when data has been exchanged via the data port within the predefined time duration.

16. A data interface device, comprising:
a data port for coupling the data interface device to an external device;
a data interface circuit coupled to the data port, the data interface circuit configured to receive a first power signal provided based on an interface power control signal and exchange data with the external device coupled via the data port; and
a power controller coupled to the data interface circuit, the power controller configured to receive a second power signal, monitor an interface operation state of the data interface circuit, and generate the interface power control signal based on the interface operation state, wherein the second power signal is distinct from the first power signal.

17. The data interface device of claim 16, wherein the power controller includes a plurality of latches configured to hold one or more state signals corresponding to the interface operation state, before and while the first power signal is disabled based on the interface power control signal.

18. The data interface device of claim 17, wherein the one or more state signals include one or more of:
a plurality of filter coefficients applied in the data interface circuit; and
a gain of an amplifier applied in the data interface circuit.

19. The data interface device of claim 16, further comprising a switch component electrically coupled to a power source and the data interface circuit, and the power controller is configured to control the switch component using the interface power control signal to provide the first power signal.

20. A method, comprising:
providing a data port for coupling the data interface device to an external device;
providing a data interface circuit coupled to the data port, the data interface circuit configured to receive a first power signal provided based on an interface power control signal and exchange data with the external device coupled via the data port; and
providing a power controller coupled to the data interface circuit, the power controller configured to receive a second power signal, monitor an interface operation state of the data interface circuit, and generate the interface power control signal based on the interface operation state, wherein the second power signal is distinct from the first power signal.
